(19) United States
(12) Patent Application Publication
(10) Pub. No.: US 2009/0154740 A1
(43) Pub. Date: Jun. 18, 2009

(54) Personal Speaker System with Detachable Control Module

(76) Inventors: Paul Regen, Felton, CA (US); Peter Garrett, Aptos, CA (US)

Correspondence Address: CENTRAL COAST PATENT AGENCY, INC, 3 HANGAR WAY SUITE D, WATSONVILLE, CA, 95076, US

(21) Appl. No.: 12/267,706

(22) Filed: Nov. 10, 2008

Related U.S. Application Data
(60) Provisional application No. 61/013,925, filed on Dec. 14, 2007.

(51) Int. Cl. H04R 5/02; G06F 13/00

(52) U.S. Cl. 381/311; 710/304

(57) ABSTRACT

A personal speaker system has one or more speakers, a wireless transceiver, and a detachable user control interface, the user control interface including a digital music player, a graphics display, and a digital medium executing software code for enabling configuration and control of system functions by a user.

### CROSS-REFERENCE TO RELATED APPLICATIONS

The present invention claims priority to a U.S. provisional patent application Ser. No. 61/013,925 entitled “ION Technologies Wireless Headset with Built-in Detachable Control Module/MP3 Player” filed on Dec. 14, 2007 the entire disclosure of which is incorporated herein at least by reference.

### BACKGROUND OF THE INVENTION

1. Field of the Invention

The present invention is in the field of audio speaker systems including wireless headsets and pertains particularly to systems coupled with modular digital music players.

2. Discussion of the State of the Art

In the field of portable audio entertainment systems, digital music players have been developed that may be docked to or tethered to various types of speaker systems. MP3 players, XM radios, I-Pods, and other device types can be tethered to and/or docked to different compatible speaker sets and systems to provide a portable control system that can be used in more than one location. Makers of speaker system units also termed docking stations in the art include Bose™, Sony™, and others.

Dedicated digital music players are often ported to aftermarket speaker systems through adapters that provide connectivity to standalone speaker units or to speaker systems connected to stereo or radio equipment. These devices may also be connected to ear buds, headsets and other personal speaker units or systems.

More recently, digital music players have been adapted to connect wirelessly to a speaker system thereby eliminating the need for a tether. Wireless reception is local and can range from a few feet up to 100 feet or more in any direction depending on the system and wireless technology used to transmit the audio stream from the player to the speaker unit or system.

Some limitations exist with respect to the flexibility of mobility of current portable music player/systems. One is that many popular players double as picture and video storage and presentation devices and have a relatively large footprint limiting the type of docking that can be achieved. An I-Pod™, for example, has a docking port that enables the device to be docked to a stationary speaker system such as a table-top Bose™ system. In order to achieve a mobile scenario with an I-Pod™, the I-Pod™ must be carried separately from the headset or earpiece used to receive audio from the device. This is true for many current devices adapted to stream digital music.

Although these current devices can be used in a wireless environment, wireless connectivity is most-often provided through an adaptive system like a personal computer or a stereo system adapted for wireless output to a headset or ear piece. The user typically has no immediate control capability from the point of the speaker system. A wireless remote control may be used to interact with a docked music player, however the user is unable to read the display from more than a few feet distant from the device. Moreover, multiple component potable systems (player, cable, and headset) may become temporarily unusable in the field due to misplacement of one of the components required to enable the system.

Therefore, what is clearly needed is a portable music system that solves the problems listed above. A system such as this would enable a more flexible environment for listening to music.

### SUMMARY OF THE INVENTION

A problem stated above is that although current audio devices can be used in a wireless environment, wireless connectivity is most-often provided through an adaptive system like a personal computer or a stereo system adapted for wireless output to a headset or ear piece. The user typically has no immediate control capability from the point of the speaker system. The inventors realized in an inventive moment that if an audio personal speaker system could be provided to operate in a flexible wireless environment using one or more detachable components more convenience and flexibility might be afforded a user.

The inventors therefore searched components of digital audio systems and wireless communications devices including media storage methods and devices looking for a mix of components that could be leveraged to provide a flexible personal speaker system and music player that could be adapted to several different functional scenarios. Every speaker system has an audio input and an audio output. Most such systems are inflexible relative to varying architectures including wireless architectures and adaptation to other non-compatible sources of audio.

In an inventive moment, the inventors conceived and subsequently provided a personal speaker system including a control module that served in different modes as a digital music player and a data storage and access device that could communicate with the speaker system and with other systems adapted for wireless communication through a wireless adapter also provided as a detachable part of the system. The result was a highly flexible system for listening to music and a convenient method for keeping track of and accessing data and other files.

Accordingly, in one embodiment of the present invention, a personal speaker system is provided comprising, one or more speakers, a wireless transceiver, and a detachable user control interface, the user control interface including a digital music player, a graphics display, and a digital medium executing software code for enabling configuration and control of headset functions by a user. In one embodiment, there are two speakers connected by headband. In one embodiment, the digital music player is an MP3 music player.

In one embodiment, the graphics display is a touch screen display integrated with the digital medium on the detachable control module. In this embodiment the digital medium is a wireless flash drive. According to a variation of this embodiment the wireless flash drive is detachable from the control module and includes a retractable USB connector.

In one embodiment personal speaker system further includes a detachable wireless adapter with an input/output (I/O) port for operating as a wireless adapter for a host audio output system not adapted for wireless transmission. In one embodiment the user control interface includes a user-operable control feature for toggling between different modes of the headset.

In another embodiment the personal speaker system further includes contact circuitry for connecting the speaker path from the digital music player to the one or more speakers thereby enabling a hardwired audio connection from the player to the speakers when the digital music player and control module is docked to the system. In one embodiment, the personal speaker system further includes a second wireless transceiver on the digital music player for receiving a command from a remote control device and for transmitting streaming music over a wireless frequency. In a preferred embodiment the speakers number more than one and are adapted for stereo sound.

Accordingly, in another embodiment of the present invention, a removable medium is provided for storing software executable thereon and media comprising a non-volatile memory for persistent storage of media and software, a volatile memory for data caching and task performance, a microprocessor for device boot and task processing, and a graphics display screen for displaying information and graphics, the medium accessible through a user control interface by docking the medium to the interface.

In one embodiment, the removable medium is operable as a USB flash drive. In a variation of this embodiment the Flash drive includes a wireless transceiver for enabling wireless reception of media to the USB flash drive and wireless send of media from the USB flash drive. In one embodiment the wireless protocol supported at the wireless transceiver is one of or a combination of wireless universal serial bus (WUSB), wireless fidelity (Wi-Fi), or Bluetooth™.

### BRIEF DESCRIPTION OF THE DRAWING FIGURES

FIG. 1 is perspective view of a personal speaker system with a detachable control module according to an embodiment of the present invention.

FIG. 2 is an elevation view of the detachable control module of FIG. 1 adapted as a music player and attached to a wrist band according to an embodiment of the present invention.

FIG. 3 is an assembly view of the detachable control module of FIG. 2 including a detachable display storage device according to an embodiment of the present invention.

FIG. 4 is a perspective view of an audio output system adapted with the wireless adapter of FIG. 1 to communicate with the detachable control module attached to the personal speaker system of FIG. 1.

FIG. 5 is a block diagram illustrating basic electronic components of the control module and wireless adapted of FIG. 1 according to an embodiment of the present invention.

### DETAILED DESCRIPTION

The inventor provides a personal speaker system (PSS) that includes a detachable control module, which in one embodiment is a combination digital music player and data storage device. In one embodiment the system also includes a detachable wireless adapter with an input audio jack for enabling the PSS to work with an audio output system that is not adapted for wireless send of digital music. The invention is described in enabling detail using various embodiments set forth below.

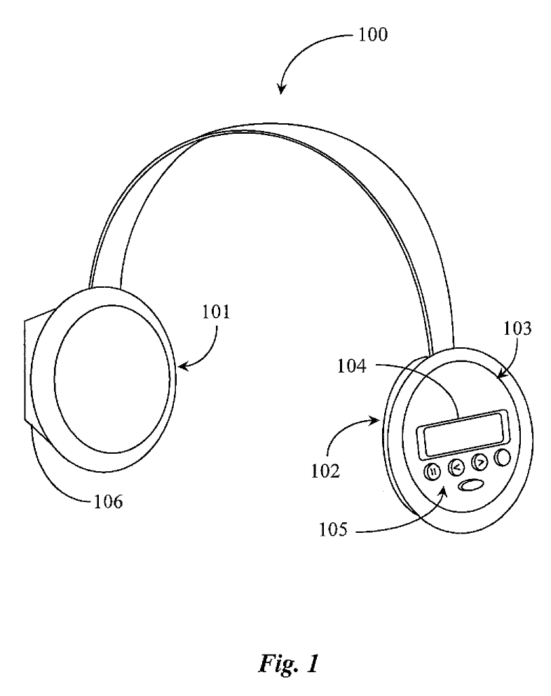

FIG. 1 is perspective view of a personal speaker system (PSS) 100 with a detachable control module 103 according to an embodiment of the present invention. PSS 100 is adapted as a speaker headset with one or more mounted speakers designed to rest over the ears of a user when the device is worn.

PSS includes a mounted speaker 101 and a mounted speaker 102. Speakers 101 and 102 may be lined on the user interfacing side with a comfortable foam material. A microphone might also be included instead of speaker 101 or in addition to both speakers of PSS 100. Speakers 101 and 102 may be enclosed in plastic casings and may be adjustable relative to the ear pattern of a user so as to enable a universal fit typical with speaker headsets.

Speaker 102 of PSS 100 serves as a mounting location for control module 103. Control module 103 is detachable from PSS 100 and is adapted as a digital music player in one embodiment. In another embodiment control module 103 might be adapted as a portable file sharing device. Control module 103 is a digital music player in this example and may be referred to in this specification as music player 103. Control module 103 may be manufactured as a small thin-profile digital device including a polymer housing enclosing the electronics of the device. Module 103 may be attached to speaker base 102 by snapping, docking, threading, or other mechanical method.

Music player 103 has a graphics display screen (GDS) 104 provided thereon and adapted as a display for the device. GDS 104 may be a light emitting diode (LED) display or an organic light emitting diode (OLED) display. Other display types may be provided without departing from the spirit or scope of the present invention such as a liquid crystal display (LCD) or a polymer light emitting diode (PLED). A user control interface 105 includes an array of controls for providing navigation, selection, and other typical control functions relative to playing music such as pause, backward, forward, and select or enter (oblong button). Other types of controls may also be provided instead of buttons like sliders, turn knobs or the like.

Display screen 104 may be adapted as a touch screen that provides a much wider array of user controls than could be mounted physically on the device in an array such as with user control interface 105. Likewise, the control buttons, sliders, or turn knobs might be multi modal controls assigned more than one possible task depending on device mode. The inventor illustrates that one or more controls 105 are not assigned with a default task to demonstrate flexibility in the design.

Display screen 104 may be provided in the present embodiment as a detachable Flash drive and display capable of serving as a universal serial bus (USB) storage drive. In this regard it is detachable from music player 103 and may be plugged into any USB port and be recognized as a standard thumb drive. In one embodiment display device 104 is a detachable Flash drive that is adapted to operate wirelessly for the purpose of streaming music to the digital player for presentation over the PSS. Speakers 102 and 101 may be connected together in a variety of different ways that might be compatible with a headset presentation. In this example, a semi-resilient headband serves as the speaker mount. The headband may also be adjusted to better fit particular users.

Speaker 101 includes a detachable wireless adapter 106 in this embodiment. Wireless adapter 106 may be detached from PSS 100 and connected to an audio output system. The connection can be accomplished by providing an audio input jack on the adapter to enable a wired audio output system to transmit wireless streaming music to PSS 100 via an audio output cable from the output system to adapter 106. Adapter 106 has a wireless transceiver that can communicate to another wireless transceiver located in digital player 103. In this embodiment, player 103 serves as a wireless receiver for the output system while it is docked into speaker 102 of PSS 100.

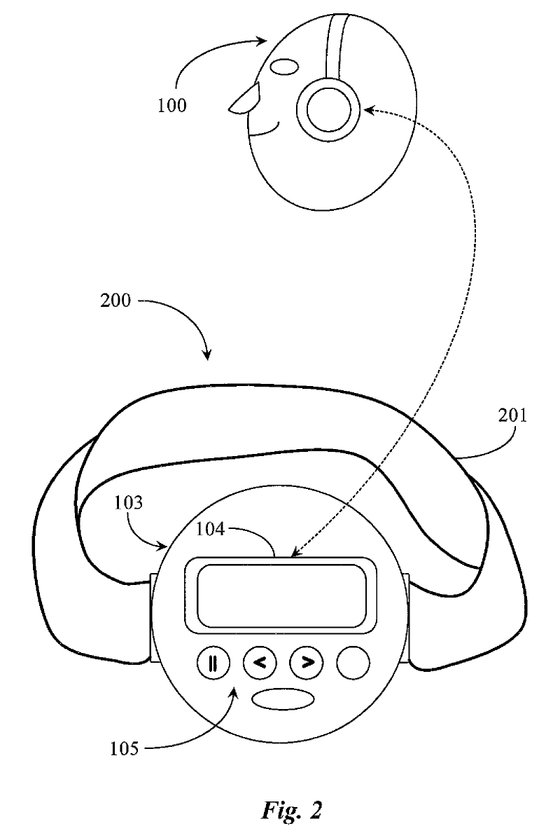

FIG. 2 is an elevation view of control module 103 of FIG. 1 adapted as a music player and attached to a wrist band according to an embodiment of the present invention. Control module (music player) 103 includes display (GDS) 104 and user control interface 105. Music player 103 is attached to a flexible arm or wrist band 201 for the purpose of serving as a wireless personal music player (PMP) 200. PSS 100 may be worn as a speaker system with player 103 detached and being worn on the wrist, arm, leg, or around the neck. In this example music player 103 transmits music wirelessly to PSS 100 via the detachable wireless adapter 106 described above. Band 201 may be manufactured of a semi flexible material like plastic or a more flexible stretch fabric. Band 201 may be provided with an adjustment mechanism for adjusting for fit.

Control module 103 has a wireless transceiver that is adapted to communicate with the wireless adapter provided on headset 100. In one embodiment, display 104 is a detachable Flash drive that hosts the wireless transceiver. In one embodiment the Flash drive is the brains of control module 103 and user control interface 105 enables both navigation of files and programs stored on the Flash drive and music player navigation and control. A user may operate control module 103 while it is detached from PSS 100 and may cause the player to stream music wirelessly to the PSS.

In one embodiment control module 103 may have one or more resident speakers that may play music by default when the music player is invoked but when it is not docked to PSS 100 or in wireless streaming mode. In one embodiment a contact bus or other contact circuitry is provided at the control module docking point on PSS 100 so that when docked and playing music, the speaker path is routed to the PSS speakers and the resident speaker or speakers on control module 103 are deactivated by default. In another embodiment control module 103 communicates wirelessly with PSS 100 whether it is docked or not and music is wirelessly transmitted from the player to the wireless adapter (106) where it is converted to analog and played over the PSS speaker or speakers. There are a variety of different options.

Control module 103 may also contain a microphone and recording SW for operation as a digital recorder. Recorded files can be streamed on playback to PSS 100 whether the control module is or is not docked to the system. Control module 103 may include an onboard power source such as a rechargeable cell or battery and may be charged by induction method or through wireless USB in one embodiment wherein display 104 is a Flash drive adapted for wireless communication.

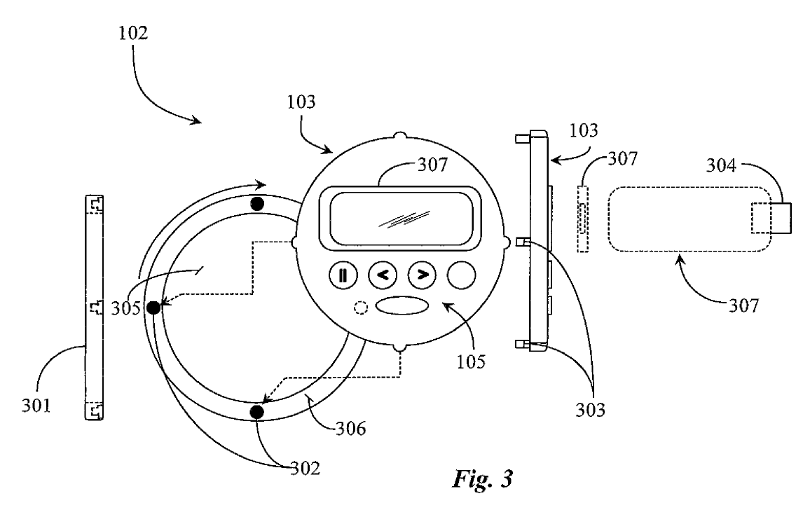

FIG. 3 is an assembly view of the detachable control module 103 of FIG. 2 including a detachable display storage device 307 according to an embodiment of the present invention. Control module 103 may be attached or docked to a docking base 301 via a simple array of openings 302 and apertures 303. In this example a bolt circle of four openings 302 is strategically located on docking base 301 and adapted to receive four apertures 303 arrayed in a like bolt circle pattern on control module 103. Openings 302 are adapted by design to retain apertures 302 in a snap like fashion such that control module 103 may be pressed onto docking base 301 securely. Control module 103 may be removed from PSS docking base 301 by prying using a tool provided and adapted for the purpose.

Docking base 301 may be resident on PSS 100. A like docking base may be provided for docking control module 103 to be worn with a band on the wrist for example. In this way, control module 103 can be detached from PSS 100 and attached to a docking base with a band already installed. In one embodiment both the docking base and control module may be detached from PSS 100. A band may be added to the docking base for adapting the module to be worn on the wrist.

In one embodiment docking base 301 comprises a center piece 305 and a peripheral ring 306. Peripheral ring 306 is rotable about center piece 305. The degree of rotation may be a full 360 degrees or freely rotable. A friction mount technique can be used to attach centerpiece 305 and ring 306 together so that the control module may be rotated to any convenient position and will stay at the last position until it is rotated again. Ring 306 supports openings 302 so that when mounted, control module 103 is rotable about center piece 305. The exact method for enabling a rotable control module is not particularly relevant to the present invention. A variety of differing designs might be considered such as providing a ratchet mechanism on the docking base that interfaces with the module to provide desired rotation of the module. The face view of control module 103 includes display 104 in one embodiment or a Flash drive 307 in another embodiment and user control interface 105. An adjacent side view of control module 103 (at right) illustrates a thin profile for the module.

Display 104 may also serve as a removable data storage device as described above. A Flash drive with display 307 is illustrated in place of display (104). A side view of Flash drive 307 is illustrated just right of control module 103 in broken line. In this example Flash drive 307 is a data storage drive or Flash drive with a graphics display screen. An elevation view of Flash drive 307 is illustrated by broken line adjacent to the illustration of the device from the side in this exemplary assembly view.

Most if not all of the entire surface of Flash drive 307 is reserved for display (104). Flash drive 307 may be detached or ejected from control module 103 and may operate as a standalone device capable of sending and receiving wireless via an onboard wireless transceiver. In one embodiment Flash drive 307 is the central brain for control module 103. Therefore all of the critical components like a power source, a micro processor, a wireless transceiver and a memory are provided onboard the Flash drive and the control module serves basically as a user operating interface to the Flash drive.

Flash drive 307 may include a retractable USB connector 304 that when extended is adapted to plug into a USB port on a host system. Flash drive 307 may communicate using wireless USB (WUSB), or other wireless protocols that support USB protocols. Flash drive 307 may also communicate via standard USB connector 304. Flash drive 307 may be charged using USB connector 304 or through a magnetic induction coil (not illustrated) provided on module 103 and adapted for the purpose.

Flash drive 307 may be ejected from control module 103 and plugged into a USB port on a computer for example. The device can be controlled through the computer host to play and wirelessly transmit digital music to PSS (100) through wireless adapter (106) attached to PSS (100). In this case all of the player software encoding/decoding software, and play list of song titles, etc. is all loaded on the Flash drive memory and is controllable by input through a computing device while plugged into a USB port on the computing device. User control interface 105 may be used to control Flash drive 307 when it is docked again to control module 103. Contact circuitry may be provided to enable interface 105 and any other features that may be provided on control module 103 once Flash drive 307 is docked like a microphone or any speaker(s) resident on module 103.

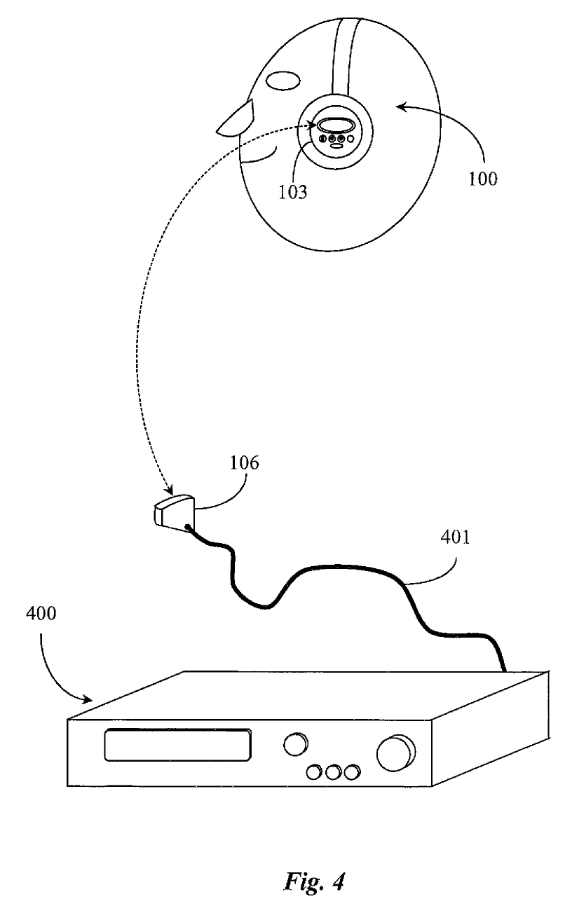

FIG. 4 is a perspective view of an audio output system 400 adapted with wireless adapter 106 of FIG. 1 to communicate with personal speaker system 100 of FIG. 1. Audio output system 400 may be a stereo, radio or any other audio output system having an audio output port to a peripheral component. System 400 includes an output port and cable 401. Cable 401 may include a jack for plugging into a 3.5 mm input port provided on wireless adapter 106. Adapter 106 receives the audio signal from system 400 and sends the signal wirelessly to PSS 100 including docked control module 103.

Wireless adapter 106 may receive digital input from system 400 and encode the input according to the wireless protocol used such as Bluetooth™, WUSB, Ultra Wideband (UWB), or others. Wireless adapter may also receive an analog signal from system 401 and may digitize the signal sending audio packets wirelessly over the link to be converted back to analog for playing over the speakers of PSS 100.

A wireless transceiver in adapter 106 transmits digitized audio to a wireless transceiver in control module 103 where the signal is converted into an analog stereo signal for speaker output. In one case bi-directionality is supported so that music may be played at control module 103 and transmitted to stereo system 400 via wireless adapter 106 where it can be played over the system's speakers. Packet loss and other error control issues are handled between the transceiver units.

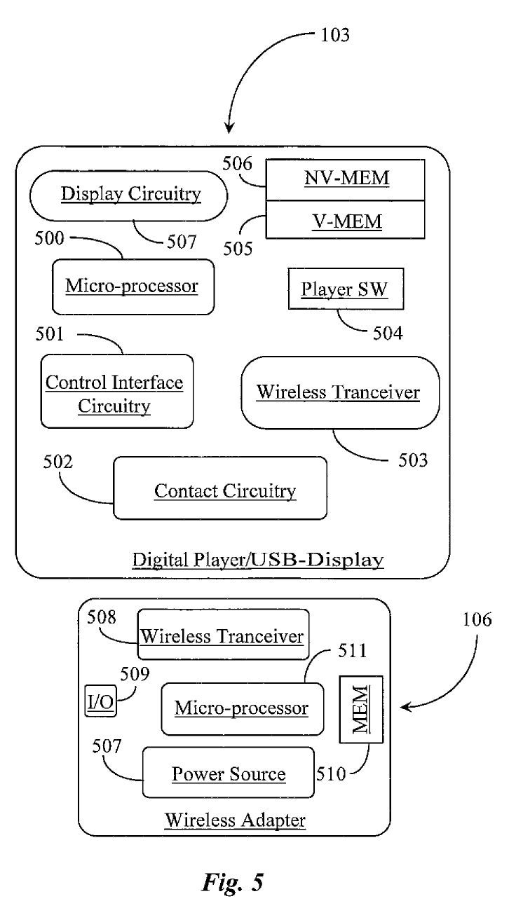

FIG. 5 is a block diagram illustrating basic electronic components of the control module and wireless adapter of FIG. 1 according to an embodiment of the present invention. Control module 103 may include a micro processor 500 for processing tasks and executing and running software. Control module 103 includes control interface circuitry 501 enabling user controls and remote operation in some embodiments.

A contact circuitry 502 may be provided to module 103 to enable hardwired speaker links, control lines, address lines, and power lines when detachable components are filly docked relative to the PSS (100) of the invention. Module 103 includes a wireless transceiver 503 for enabling wireless communication with other units. Module 103 is a digital music player in one embodiment and therefore includes music player SW 504 and may include other supporting software including a miniature operating system, etc. Control module 103 includes a non-volatile memory (NV-MEM) block 506 for storing persistent information such as documents, music files, photos, and programs. NV-MEM 506 may be a Flash-based memory. A volatile memory (V-MEM) 505 is provided within module 103 such as random access memory (RAM) for caching data, error correction, and other runtime tasks. A display circuitry 507 is provided within module 103 and is adapted to enable display of graphics, status and other necessary indicators.

A detachable data storage device functioning as a wireless Flash drive with a display may host most of the components just described with the exceptions of the contact circuitry and the control interface circuitry. In this embodiment the data storage device includes the executable software for operation as a digital player or a file storage and access device. Module 103 includes a power source module such as a battery or power cell that may be charged by magnetic induction and/or through a USB interface to a host system. In the case of USB, the power source would be onboard the Flash drive.

Wireless adapter 106 contains a wireless transceiver 508 for enabling wireless communication with other devices. A micro-processor 511 may be included in wireless adapter 106 for processing tasks and for executing firmware and or software. A memory (MEM) block may be provided within wireless adapter for storing software or firmware and for temporary caching of data. A power source such as a battery or power cell may be provided to wireless adapter 106. In one embodiment wireless adapter 106 is powered by control module 103 when both devices are docked to the PSS.

In one embodiment wireless adapter 106 may be charged by magnetic induction or through a USB interface is a USB connector is provided for the purpose. In one embodiment a DC charging unit may be provided as an accessory to charge control module 103 and wireless adapter 106. An input/output (I/O) port is provided on wireless adapter 106 for enabling wireless adaptation of host audio output systems. In one embodiment adapter 106 enables both wireless output from a host audio system and wireless input to a host audio system.

It will be apparent to one with skill in the art that the personal speaker system of the invention may be provided using some or all of the mentioned features and components without departing from the spirit and scope of the present invention. It will also be apparent to the skilled artisan that the embodiments described above are exemplary of inventions that may have far greater scope than any of the singular descriptions. There may be many alterations made in the descriptions without departing from the spirit and scope of the present invention.

What is claimed is:

1. A personal speaker system comprising;
one or more speakers;
a wireless transceiver; and
a detachable user control interface, the user control interface including a digital music player, a graphics display, and a digital medium executing software code for enabling configuration and control of system functions by a user.

2. The personal speaker system of claim 1 including two speakers connected by headband.

3. The personal speaker system of claim 1 wherein the digital music player is an MP3 music player.

4. The personal speaker system of claim 1 wherein the graphics display is a touch screen display integrated with the digital medium on the detachable control module.

5. The personal speaker system of claim 4 wherein the digital medium is a wireless flash drive.

6. The personal speaker system of claim 5 wherein the wireless flash drive is detachable from the control module and includes a retractable USB connector.

7. The personal speaker system of claim 1 further including a detachable wireless adapter with a 3.5 millimeter jack for operating as a wireless adapter for a host audio output system not adapted for wireless transmission.

8. The personal speaker system of claim 1 wherein the user control interface includes a user-operable control feature for toggling between different modes of the headset.

9. The personal speaker system of claim 1 further including contact circuitry for connecting the speaker path from the digital music player to the one or more speakers thereby enabling a hardwired audio connection from the player to the speakers when the digital music player and control module is docked to the system.

10. The personal speaker system of claim 1 further including a second wireless transceiver on the digital music player for receiving command from a remote control device and for transmitting streaming music over a wireless transmission frequency.

11. The personal speaker system of claim 1 wherein the speakers number more than one and are adapted for stereo sound.

12. A removable medium for storing software executable thereon and media comprising a non-volatile memory for persistent storage of media and software, a volatile memory for data caching and task performance, a microprocessor for device boot and task processing, and a graphics display screen for displaying information and graphics, the medium accessible through a user control interface by docking the medium to the interface.

13. The removable medium of claim 12 operable as a USB flash drive.

14. The removable medium of claim 13 further including a wireless transceiver for enabling wireless reception of media to the USB flash drive and wireless send of media from the USB flash drive.

15. The personal speaker system of claim 1 wherein the wireless protocol supported at the wireless transceiver is one of or a combination of wireless universal serial bus (WUSB), wireless fidelity (Wi-Fi), or Bluetooth™.
